(19) United States
(12) Patent Application Publication
(10) Pub. No.: US 2011/0106348 A1
(43) Pub. Date: May 5, 2011

(54) DEVICE FOR DRIVING A VEHICLE, IN PARTICULAR A WATERCRAFT

(75) Inventors: Christian Krause, Guetersloh (DE); Hans-Joachim Herbermann, Paderborn (DE)

(73) Assignee: FISCHER PANDA GMBH, Paderborn (DE)

(21) Appl. No.: 12/894,355

(22) Filed: Sep. 30, 2010

(30) Foreign Application Priority Data
Nov. 4, 2009 (DE) 20 2009 015 026.7

(51) Int. Cl. B60L 15/00; B63H 21/17; B60L 11/02

(52) U.S. Cl. 701/21; 701/22; 903/903

(57) ABSTRACT

This present invention relates to a device for driving a vehicle, in particular a watercraft, which comprises a combustion engine adapted to coact with a generator for generation of electrical energy, an energy storage device adapted to coact with the generator via a rectifier for storage of electrical energy made available by the generator and for energy output as and how required, and a drive system that is adapted to be activated by a motor control device and that comprises at least one electric motor wherein the energy for operating the electric motor can be supplied by the generator and/or the energy storage device at option and wherein said motor control device comprises at least two functionally independent motor control modules for operating the electric motor.

This present invention relates to a device for driving a vehicle, in particular a watercraft, which comprises a combustion engine adapted to coact with a generator for generation of electrical energy, an energy storage device adapted to coact with the generator via a rectifier for storage of electrical energy made available by the generator and for energy output as and how required, and a drive system that is adapted to be activated by a motor control device and that comprises at least one electric motor wherein the energy for operating the electric motor can be supplied by the generator and/or the energy storage device at option.

It is generally known in the art to drive ships and other maritime objects by means of a Diesel-electric drive in which case electrical energy is produced by means of a combustion engine and a generator coupled to said engine to operate an electric motor for driving a propeller. The electric motor may for instance be arranged distant from the generator and close to the propeller and can draw electrical energy from the generator direct while the latter is running. Also known are so-called hybrid drive systems for ships and other maritime objects wherein electrical energy made available by the generator may be interim stored in an energy storage device such as a battery. The electric motor is operable with the energy thus stored in the energy storage device. In that case, the propeller is driven by the electric motor independent of generator operation, for instance time shifted relative thereto. With the generator cut out it is possible to propel the ship with exceptionally low noise involved which is for instance of advantage when entering a harbor.

It has been for a long time that Diesel-electric and/or hybrid drive systems have been used as auxiliary drives for sail ships or for vessels primarily driven the Diesel-mechanical way in which a combustion engine is connected to the propeller via a shaft, though now these drive systems are increasingly being used as main drives with no alternative drives provided such as of Diesel-mechanical type. More than ever is a high degree of operational safety and reliability demanded in that case since any ship that is unable to advance and/or navigate is a severe safety risk to both the crew and to other vessels.

It is an object of this present invention, therefore, to improve a Diesel-electric or hybrid drive system for vehicles, in particular watercrafts, in such a way that the reliability and economy thereof is increased.

To achieve this object the invention is in conjunction with the preamble of patent claim 1 characterized by the fact that the motor control device comprises at least two functionally independent motor control modules for operating the electric motor.

The particular advantages of this invention resides in that the operational safety and reliability of the drive system are increased due to the redundance provided in the motor control area. Since the motor control device comprises two completely independent motor control modules it is possible for the at least one electric motor to keep on operating via the second module in case of failure of one of said two modules. The cruising and navigating ability of the vehicle are ensured even when either one of the two motor control modules fails such that safety and reliability are improved.

The term “control” as used in this document will be understood to include regulating functions also. In particular, it is possible to implement a regulating function and/or regulating algorithm by means of the motor control system or one of the control modules, respectively.

According to a preferred embodiment of this invention the electric motor has at least two active branches of which the first one can be activated by the first motor control module and the second one by the second module. This affords the advantage that in case of failure of one of the two motor control modules the electric motor can be kept operating without need for changeover from the defective motor control module to a spare module. Since both motor control modules are continuously being used it is not possible for a defect of the inactive spare motor control module to occur undiscovered. In addition, the drive system is redundant also in the drive system area now so that in case of failure of one of the windings the motor will be enabled to keep on operating by means of the second winding not affected by failure. The operational safety and reliability of the drive system are increased even further this way.

According to a modification of this invention the drive system comprises two electric motors of which a first one is operated via the first motor control module and a second one via the second module. An advantage also in that case is that redundance is provided in the drive system area. Only one of two drive branches gets inactive when one of the two electric motors or one of the two control units fails while a second drive branch will not be affected by failure and will be available for driving and navigating the ship.

Another modification of the invention provides for at least one motor control module to be provided a frequency converter for variable speed operation of the electric motor connected to that particular module. This affords the advantage that the vehicle can be driven very sensitively and variably so that the speed of a vessel for instance can be varied over a very vast set range via the torque provided by the electric motor.

In a still further modification the first and the second control modules are of identical design with the advantage for consequence that economy is increased. Moreover will system maintenance by a service technician be facilitated and can spare parts or replacement motor control modules be provided with but very little logistic effort involved.

A further modification of the invention provides for at least one control module to be a converter adapted for four-quadrant operation. The resultant advantage is that the electric motor will be operable as generator and that the electrical energy obtained via said converter can be fed into the energy storage device. Operation of the ship gets particularly economic that way since the overall efficiency of the drive system is improved due to energy recovery. Also the possibility exists, particularly for sail ships, to recharge the batteries for driving the electric motor in case of failure of generator or combustion engine and/or to provide on-board power supply. The drive system is given additional redundance in the energy recovery field such that operational safety and reliability is increased even further.

Another modification of this invention provides for the motor control device to be data-technically coupled to a superordinate central control system in such a way that control signals from the central control system will be picked up by the motor control device and processed to generate local control parameters. This affords the advantage that the motor control device can cooperate with other control units likewise coacting with the central control system, for instance a control unit for battery management or a generator control unit. The operating point of the electric motors, for instance, can be selected such that an overall efficiency of the drive system is optimally set.

Further advantages of the invention are as defined in the subclaims.

Exemplary embodiments of this present invention will hereafter be described in closer detail now with reference to the accompanying drawings.

In these drawings:

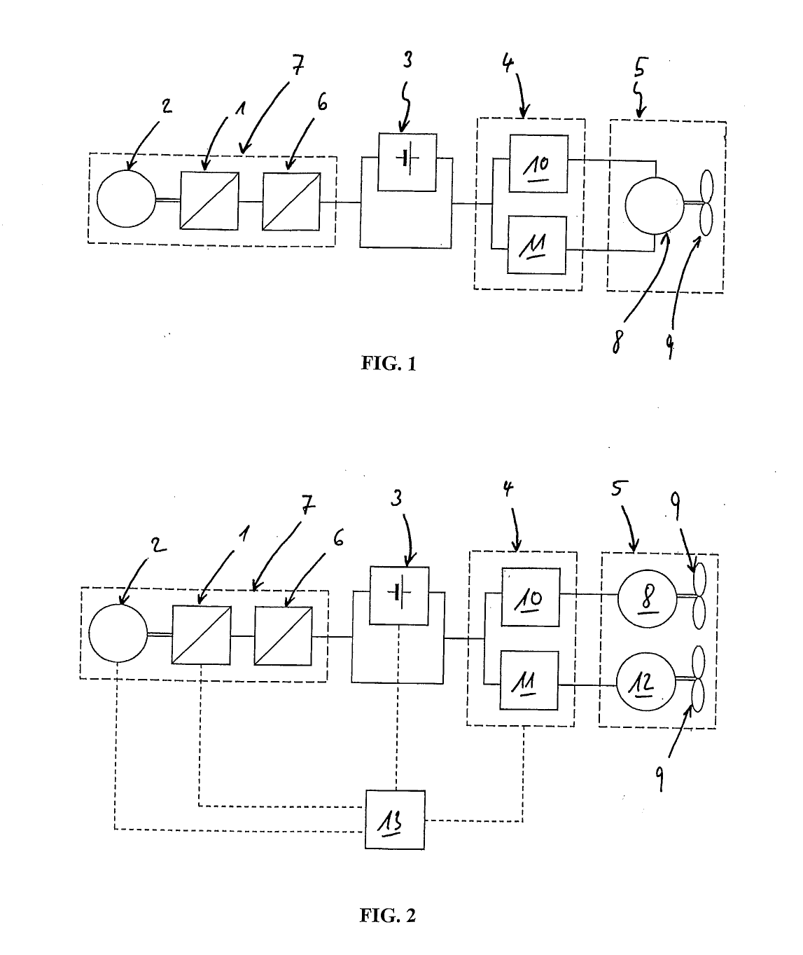

FIG. 1 is a schematic representation of a first embodiment of the invention and

FIG. 2 is a schematic representation of a second embodiment of this invention.

A device for driving a vehicle, in particular a watercraft such as a ship or other maritime object, substantially consists of a generator 1 driven by a combustion engine 2, an energy storage device 3 coupled to said generator 1 such as an accumulator, a motor control device 4 and a drive system 5. Generator 1 and combustion engine 2 are typically combined into a common structural unit with a rectifier 6 that serves for rectifying the electrical energy made available by the generator 1. The drive system 5 is formed by an electric motor 8, in particular an AC motor, and a propeller 9 for driving the vehicle.

Drive systems of that type are called hybrid drive systems that are used for instance as auxiliary drives for sail ships and/or primary Diesel-mechanical drives for large trading and passenger vessels. Moreover are these driving systems increasingly being employed as sole cruising drives for motor boats. An advantage afforded by provision of such drive systems is a particularly sensitive and variable steering control of the vehicle. Other important advantages are offered in regard to the arrangement of drive components aboard the ship since an exceptionally high degree of geometrical freedom exists due to omission of a drive shaft which is mandatory in Diesel-mechanical drive systems. Also can the structural unit 7 with generator 1 and combustion engine 2 be of very compact and low-noise design such that the drive is exceptionally silent. Moreover it is a known practice to omit the energy storage device 3 and to connect the generator 1 direct to the electric motor 8.

The electric motor 8 has two not-shown windings which are for instance arranged in tandem. Each of these windings is separately connected to the motor control device 4, namely a first winding with a first motor control module 10 and a second winding with a second motor control module 11 of the motor control device 4. Activating the electric motor 8 via both motor control modules 10, 11 will permit the electric motor 8 to operate at full power while upon failure of one of the motor control modules 10, 11 or one of the windings of the electric motor 8 said latter will be enabled to keep operating at reduced capacity via the remaining drive branch comprising the other of the control modules 10, 11 and the other winding. This means that the driving and navigating ability of the vehicle will be retained when one of the windings and/or one motor control modules is out of order.

The drive system is redundant also in its energy supply area. Energy for operating the drive system 5 can be optionally made available direct by the generator 1, by the energy storage device 3 or commonly by both the generator 1 and the storage device 3. The energy storage device 3 is available for feeding the drive system 5 unchanged when the generator 1 fails. Possible defects in that case may occur either direct on the generator 1, the combustion engine 2 or the rectifier 6. The drive system 5 can be direct supplied with power from the generator 1 when the energy storage device 3 is defective.

This implies that all components of the drive system are redundant designed: on the energy supply side are the generator 1 and the energy storage device 3 in a functionally parallel arrangement while on the motor control side the first motor control module 10 and the second motor control module 11 are redundant and in the area of the drive system 5 there is an electric motor 8 with two windings provided of which one is connected to the first motor control module 10 and the other to the second control module 11. All this is a contribution to increased operational safety and reliability.

The electric motor 8 can be supplied with energy from the generator 1 and the energy storage device 3 at the same time. Provision may be made, for instance, that the electric motor 8 cannot be operated at full capacity via the generator 1 alone so that the generator 1 can be of particularly small size, compact and inexpensive. Maximum power will not be made available unless both the generator 1 and the energy storage device 3 supply energy to the electric motor 8.

The first motor control module 10 and the second control module 11 of the motor control device 4 are arranged close to each other in one common casing in spite of their functional independence. The motor control device 4 may for instance be disposed adjacent to the generator 2 or to the electric motor 8. The motor control modules 10, 11 can be cooled by a common cooling unit which has one common cooling body, common cooling channels or a common coolant pump. It is possible also that the first and the second motor control modules 10, 11 are for instance provided with a common circuit board.

The two motor control modules 10, 11 are in the form of converters which are adapted to transmit energy from the generator 1 and/or the energy storage device 3 to the electric motor 8 and from the electric motor 8 to a battery 3. With said converters 10, 11 operating in the so-called 4-quadrant mode it is possible under conditions of sailing or braking for instance to recover energy and to charge it back into the energy storage device 3. Energy recovery in that case is possible even when the generator is not operating. This may for instance be relevant in case of failure of generator 1, combustion engine 2 or rectifier 6. To this end, the motor control module 10, 11 is in the form of a line commutated inverter which is fed from capacitors under conditions of rising capacitor voltage and feeds energy from the intermediate circuit of the inverter 10, 11 back into the energy storage device 3.

An alternative embodiment of this invention according to FIG. 2 relates to a structural unit 7 which comprises a generator 1, a combustion engine 2 and a rectifier 6 and which coacts with the energy storage device 3 and the motor control device 4 in known manner. The drive system 5 however consists of a first electric motor 8 and a second electric motor 12 of which each drives one propeller 9 of its own. The electric motors 8, 12 are for instance provided with just one winding and the first electric motor 8 is activated via a first motor control module 8 and the second electric motor 12 via a second motor control module 11.

Identical components and component functions are denoted by identical reference signs.

In case of failure of one of the two electric motors 8, 12 and/or one of the motor control modules 10, 11 the driving and navigating functions of the vehicle are kept up via the intact electric motor 8, 12 and the associated motor control module 10, 11.

The drive system moreover comprises a central control unit 13 which is adapted to coact with the motor control device 4, the energy storage device 3, the generator 1 and the combustion engine 2. This central control component 13 can take over control of the generator 1, the combustion engine 2 and/or the energy storage device 3 direct or coact with any not-shown subordinate control device assigned thereto. Provision of said central control component 13 which may be connected to further functional units of the vehicle other than the communication channels shown affords the advantage that optimization of the energy management aboard the vehicle can be achieved. Thus it is possible that the energy storage device 3 can supply energy to other electric consumers on board of the vehicle with said central control unit 13 used to control these consumers.

Data-technical coupling of the central control unit 13 with subordinate control facilities, especially with motor control device 4, may be line or wireless type such as a point-to-point connection or a bus-based communication.

1. A device for driving a vehicle, which comprises a combustion engine adapted to coact with a generator for generation of electrical energy, an energy storage device adapted to coact with the generator via a rectifier for storage of electrical energy made available by the generator and for energy output as and how required, and a drive system that is adapted to be activated by a motor control device and that comprises at least one electric motor wherein the energy for operating the electric motor can be supplied by the generator and/or the energy storage device, wherein the motor control device (4) has at least two functionally independent motor control modules (10, 11) for activating the electric motor (8, 12).

2. The device according to claim 1, wherein the electric motor (8, 12) is provided with at least two windings of which a first one can be activated by a first motor control module (10) and a second one is for activation by a second motor control module (11).

3. The device according to claim 1, wherein the drive system (5) comprises at least two electric motors (8, 12) of which a first motor (8) can be activated by the first motor control module (10) and a second motor by the second motor control module (11).

4. The device according to claim 1, wherein at least one of the motor control modules (10, 11) is a frequency converter for variable speed operation of the electric motor (8, 12).

5. The device according to claim 1, wherein the first motor control module (10) and the second motor control module (11) are of identical design.

6. The device according to claim 1, wherein the first and the second motor control modules (10, 11) are arranged in one common casing.

7. The device according to claim 1, wherein a cooling unit common to the first and the second motor control module (10, 11) is provided to cool at least individual components of said motor control modules (10, 11).

8. The device according to claim 1, wherein a circuit board common to the first and the second motor control module (10, 11) is provided.

9. The device according to claim 1, wherein at least one of the motor control modules (10, 11) is a frequency converter operable in the 4-quadrant mode in which case the electric motor (8, 12) is operated as generator (1) and the electrical energy produced in said electric motor (8, 12) used as generator (1) is stored in the energy storage device (3) via said converter (10, 11).

10. The device according to claim 1, wherein the motor control device (4) is data-technically coupled to a superordinate central control unit (13) in such a way that control signals emitted by said central control unit (13) are picked up by the motor control device (4) and processed to generate local control parameters.

11. A watercraft comprising:
a combustion engine adapted to coact with a generator for generation of electrical energy,
an energy storage device adapted to coact with the generator via a rectifier for storage of electrical energy made available by the generator and for energy output as and how required, and
a drive system that is adapted to be activated by a motor control device and that comprises at least one electric motor wherein the energy for operating the electric motor is supplied by the generator and/or the energy storage device,
wherein the motor control device (4) has at least two functionally independent motor control modules (10, 11) for activating the electric motor (8, 12).

12. The watercraft according to claim 11, wherein the electric motor (8, 12) is provided with at least two windings of which a first one can be activated by a first motor control module (10) and a second one is for activation by a second motor control module (11).

13. The watercraft according to claim 11, wherein the drive system (5) comprises at least two electric motors (8, 12) of which a first motor (8) can be activated by the first motor control module (10) and a second motor by the second motor control module (11).

14. The watercraft according to claim 11, wherein at least one of the motor control modules (10, 11) is a frequency converter for variable speed operation of the electric motor (8, 12).

15. The watercraft according to claim 11, wherein the first motor control module (10) and the second motor control module (11) are of identical design.

16. The watercraft according to claim 11, wherein the first and the second motor control modules (10, 11) are arranged in one common casing.

17. The watercraft according to claim 11, wherein a cooling unit common to the first and the second motor control module (10, 11) is provided to cool at least individual components of said motor control modules (10, 11).

18. The watercraft according to claim 11, wherein a circuit board common to the first and the second motor control module (10, 11) is provided.

19. The watercraft according to claim 11, wherein at least one of the motor control modules (10, 11) is a frequency converter operable in the 4-quadrant mode in which case the electric motor (8, 12) is operated as generator (1) and the electrical energy produced in said electric motor (8, 12) used as generator (1) is stored in the energy storage device (3) via said converter (10, 11).

20. The watercraft according to claim 11, wherein the motor control device (4) is data-technically coupled to a superordinate central control unit (13) in such a way that control signals emitted by said central control unit (13) are picked up by the motor control device (4) and processed to generate local control parameters.
